(19) United States
(12) Patent Application Publication
(10) Pub. No.: US 2004/0222980 A1
(43) Pub. Date: Nov. 11, 2004

(54) Apparatus for changing representation contents on sub-display of dual-folder type mobile communication terminal

(76) Inventor: Byoung-Gon Lee, Ichon-shi (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/749,994

(22) Filed: Dec. 30, 2003

(30) Foreign Application Priority Data
Apr. 24, 2003 (KR) 2003-26064

(51) Int. Cl. G09G 5/00

(52) U.S. Cl. 345/184

(57) ABSTRACT

An apparatus for changing representation contents on a sub-display of a mobile communication terminal is disclosed. The apparatus includes: a rotary switch rotatably installed around a front circumferential portion of the sub-display provided in a dual-folder type mobile communication terminal; a rotation detecting sensor installed adjacent to a back portion of the rotary switch inside a case of the terminal, for sensing a rotation of the rotary switch to generate a predetermine input signal; and a controller installed inside the case of the terminal, the controller having one side connected to the rotation detecting sensor and the other side connected to the sub-display, wherein the controller generates different output signals according to the input signal outputted from the rotation detecting sensor to thereby display different contents on the sub-display.

### FIELD OF THE INVENTION

The present invention relates to an apparatus for changing representation contents on a sub-display of a dual-folder type mobile communication terminal; and, more particularly, to an apparatus for changing representation contents on a sub-display of a mobile communication terminal, in which a variety of information can be obtained through the sub-display with a simple manipulation without regard to a closing/opening state of a folder since the representation contents of the sub-display are changed according to a rotation of a rotary switch disposed at a circumference of the sub-display, and an adornment effect due to the sub-display can also be enhanced.

### DESCRIPTION OF THE PRIOR ART

Mobile communication terminals such as cellular phones or personal communication systems (PCSs), which are generally used, are classified into a flip type and a folder type. The folder-type mobile communication terminal includes a display (e.g., a liquid crystal display (LCD)) which is disposed at a folder. Compared with the flip-type mobile communication terminal, the folder-type mobile communication terminal tends to be widely used in recent years because it can be manufactured in a relatively small size and it is easy to implementing a large-scaled display in the flip-type mobile communication terminal.

In a general folder-type mobile communication terminal, however, a display is mounted on one surface of a folder facing a terminal main body, so that there is troublesomeness that the user must open the folder when identifying time and caller.

For the purpose of solving the problem, a dual-folder type mobile communication terminal has been proposed and widely used in recent years. According to the dual-folder type mobile communication terminal, a sub-display is additionally mounted on an outer portion of the terminal folder while a main display is generally mounted on an inner portion thereof. Therefore, the user can check desired information through the sub-display without opening the folder.

In the dual folder type mobile communication terminal, however, the representation contents displayed on the sub-display is limited to the previously set time or the caller information. As a result, it is impossible to provide a variety of desired information through the sub-display and an adornment effect is insignificant.

Further, the conventional dual-folder type mobile communication terminal is troublesome that the user must open the folder and manipulate key buttons while looking at the main display in order to obtain desired information. Even when the user wants to change the representation contents on the sub-display, the user must open the folder and manipulate key buttons disposed on the main body, so that the usage of the mobile communication terminal becomes very troublesome.

### SUMMARY OF THE INVENTION

It is, therefore, an object of the present invention to provide an apparatus for changing representation contents on sub-display of a mobile communication terminal, in which a variety of information can be obtained through the sub-display with a simple manipulation without regard to a closing/opening state of a folder since the representation contents on the sub-display are changed according to a rotation of a rotary switch disposed at a circumference of the sub-display.

It is another object of the present invention to provide an apparatus for changing representation contents on a sub-display of a mobile communication terminal, which is capable of providing various products and various functions according to user's taste by enhancing an adornment effect due to the sub-display.

In accordance with one aspect of the present invention, there is provided an apparatus for changing representation contents on a sub-display of a mobile communication terminal, including: a rotary switch rotatably installed around a front circumferential portion of the sub-display provided in a dual-folder type mobile communication terminal, the rotary switch having an opening formed at a central portion such that the sub-display is exposed outwardly; a rotation detecting sensor installed adjacent to a back portion of the rotary switch inside a case of the terminal, for sensing a rotation of the rotary switch to generate a predetermine input signal; and a controller installed inside the case of the terminal, the controller having one side connected to the rotation detecting sensor and the other side connected to the sub-display, wherein the controller generates different output signals according to the input signal outputted from the rotation detecting sensor to thereby display different contents on the sub-display.

In accordance with the present invention, the controller includes: a memory device installed in one side of a circuit board embedded in the terminal, for storing data to be displayed on the sub-display; and a microprocessor installed an the other side of the circuit board, for loading and processing the data stored in the memory device according to the input signals outputted from the rotation detecting sensor and transferring the processed signals to the sub-display.

In accordance with the present invention, the rotary switch includes a plurality of protrusions formed on a circumferential portion of the rotary switch at predetermined intervals along a circumferential direction, and a locking member is formed at one side of a terminal case adjacent to the protrusions of the rotary switch, in which the locking member has a groove formed in a shape corresponding to the protrusion.

In accordance with the present invention, the rotary switch includes: a body formed in a ring shape; and a plurality of protrusion pieces protruded inwardly or outwardly in a radial direction at predetermined intervals along a circumferential direction, and the rotation detecting sensor is an optical sensor, the optical sensor including: a light-emitting unit for radiating light toward the protrusion pieces; and a light-receiving unit for sensing the light reflected by the protrusion pieces.

In accordance with the present invention, the rotary switch includes: a body formed in a ring shape; and a plurality of magnets attached to the body at predetermined intervals along a circumferential direction, and the rotation detecting sensor is a magnetic sensor for sensing a magnetic field of the magnet approaching thereto due to a rotation of the rotary switch.

### BRIEF DESCRIPTION OF THE DRAWINGS

The above and other objects and features of the present invention will become apparent from the following description of the preferred embodiments given in conjunction with the accompanying drawings, in which:

FIG. 1 is a front view illustrating an apparatus for changing representation contents on a sub-display of a mobile communication terminal in accordance with a preferred embodiment of the present invention;

FIG. 2 is an exploded perspective view of an apparatus for changing representation contents on a sub-display of a mobile communication terminal shown in FIG. 1;

FIG. 3 is a block diagram illustrating a controller of an apparatus for changing representation contents on a sub-display of a mobile communication terminal in accordance with the present invention;

FIG. 4 is a usage state diagram of an apparatus for changing representation contents on a sub-display of a mobile communication terminal in accordance with the present invention; and

FIG. 5 is a plan view illustrating a rotary switch and a rotation detecting sensor of an apparatus for changing representation contents on a sub-display of a mobile communication terminal in accordance with the present invention.

### DETAILED DESCRIPTION OF THE PREFERRED EMBODIMENTS

Hereinafter, a detailed description of the preferred embodiments will be made with reference the accompanying drawings.

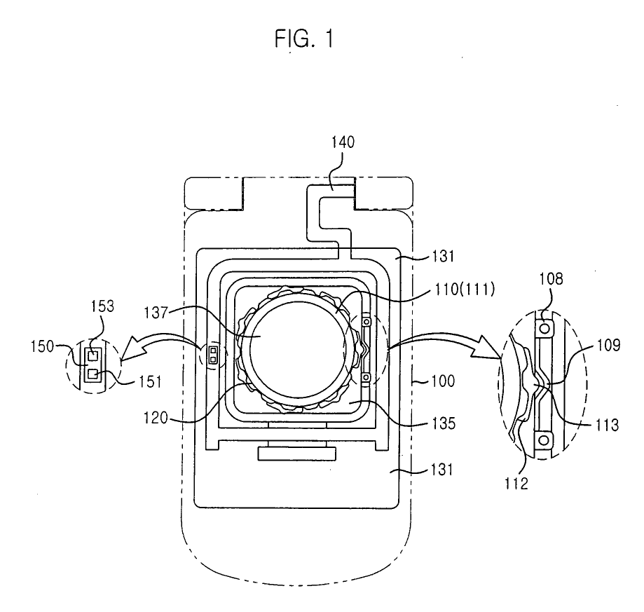

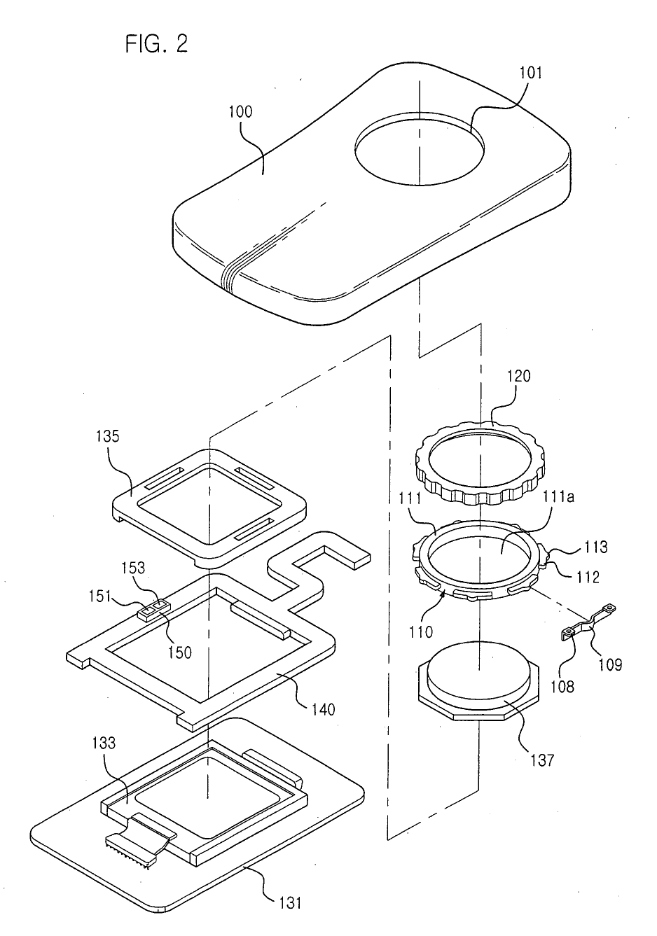

FIGS. 1 and 2 are a front view and an exploded perspective view illustrating an apparatus for changing representation contents on a sub-display of a mobile communication terminal in accordance with a preferred embodiment of the present invention.

The apparatus for changing representation contents on the sub-display in accordance with the present invention is applied to a folder of a dual-folder type mobile communication terminal. Referring to FIGS. 1 and 2, the apparatus of the present invention includes: a rotary switch 110 rotatably installed in a front portion of the sub-display 130 that is mounted on a folder case 100 of the terminal; a rotation detecting sensor 150 installed adjacent to the back of the rotary switch 100 inside the folder case 100; and a controller installed inside the folder case 100, in which the controller has one side connected to the rotation detecting sensor 150 and the other side connected to the sub-display 130.

Here, the sub-display 130 is provided with a typical display. The sub-display 130 includes: a display circuit board 131 mounted inside the folder case 100; a display panel 133 mounted on a front portion of the display circuit board 131, for displaying predetermined contents according to signals outputted from the circuit board 131; a frame-shaped panel cover 135 mounted on a front portion of the display panel 133; and a display window 137 formed of a transparent material and mounted on a front portion of the panel cover 135, in which a front portion of the display window 137 is exposed through a circular ring 101 formed at the folder case 100. A flexible printed circuit (FPC) 140 is installed in one side of the display circuit board 131. Here, the flexible printed circuit (FPC) 140 is connected to a main circuit board embedded in the main body.

The rotary switch 110 is rotated around the sub-display 130 by a predetermined angle through a user's manipulation. At this point, the rotary switch 110 is rotatably installed in the circumference of the display window 137 so that the rotation can be sensed through the rotation detecting sensor 150. Additionally, the rotary switch 110 includes a ring-shaped body 111 and a plurality of protrusion pieces 112. The ring-shaped body 111 has a circular opening 111a in order to expose the display window 137 out of the folder case 100, and the plurality of protrusion pieces 112 are outwardly protruded on the body 111 along a circumferential direction at predetermined intervals.

Further, a rotary ring 120 is attached to the front portion of the rotary switch 110 so that it can be externally exposed through the circular ring 101 of the folder case 100. Preferably, prominence and depression patterns are formed on the rotary ring 120 in order allow the user to easily turn it with hand. Accordingly, if the rotary ring 120 rotates, the rotary switch 110 can rotate as one body together with the rotary ring 120.

Additionally, protrusions 113 that are protruded outwardly in a radial direction are formed in the outer portions of the respective protrusion pieces 112 provided in the rotary switch 110, such that the protrusions 113 are arranged along the circumferential direction at predetermined intervals. A locking member 108 is attached to an inner side of the folder case 100 disposed adjacent to the protrusions 113. A central portion of the locking member 108 is curved by a predetermined angle so that a groove 109 formed in a shape corresponding to the protrusions 113 is formed in the locking member 108.

The locking member 108 is formed of elastic materials such as metal so that some elastic resistivity is applied when the protrusions 113 enters or releases the groove 109. Accordingly, in case the rotary switch 110 is rotated using the rotary ring 120, the user can feel its clicking at every rotation angle.

The rotation detecting sensor 150 senses the rotation of the rotary switch 110 to generate an input signal according to the rotation. The rotation detecting sensor 150 in accordance with an embodiment of the present invention is provided with an optical sensor which includes a light-emitting unit 151 for radiating light with a predetermined luminous intensity, and a light-receiving unit 153 for sensing the radiated light.

The optical sensor 150 is installed in the FPC disposed in the front portion of the display circuit board 131 140 by using a surface mounting technology. At this point, the optical sensor 150 is installed so that the light-emitting unit 151 and the light-receiving unit 153 can face a back of one protrusion piece among the plurality of protrusion pieces 112. Accordingly, if the rotary switch 110 is rotated, the protrusion pieces 112 pass through the front of the optical sensor 150 and its rotation is sensed. The different input signals can be generated since the sensed number of the protrusion pieces 112 is changed according to the rotation angle of the rotary angle.

At this point, a lower surface of the protrusion 112 acts as a reflective member for reflecting the light radiated from the optical sensor 150. Therefore, it is preferable to perform a hard facing process in order to increase the light reflectivity or to coat the lower surface of the protrusion 112 with a high-reflectivity material.

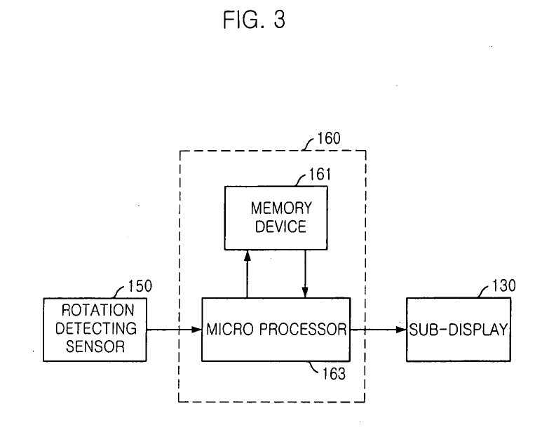

FIG. 3 is a block diagram illustrating the controller of the apparatus for changing the representation contents on the sub-display in accordance with the present invention. As shown in FIG. 3, the controller 160 generates the different signals according to the signals inputted from the optical sensor 150 to thereby display different contents on the sub-display 130. The controller 160 includes: a memory device 161 disposed in one side of the display circuit board 131, for storing data to be displayed on the sub-display 130; and a microprocessor 163 disposed in the other side of the display circuit board 131, for loading and processing the data stored in the memory device 161 according to the signals inputted from the optical sensor 150 and transferring the processed signals to the sub-display 130.

Here, the memory device 161 and the microprocessor 163 can be mounted on the display circuit board 131 or the main circuit board. Alternatively, the memory device 161 and the microprocessor 163 can be provided separately.

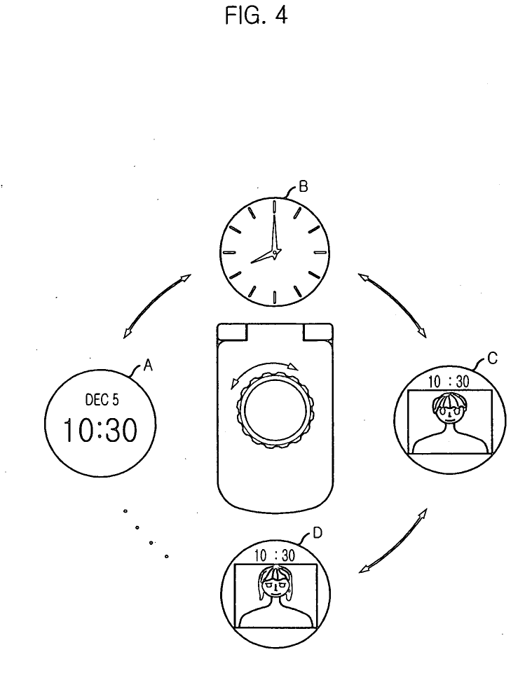

Hereinafter, an operation of the apparatus for changing representation contents on the sub-display of the mobile communication terminal in accordance with the present invention will be described with reference to FIG. 4.

FIG. 4 is a usage state diagram of the apparatus for changing the representation contents on the sub-display of the mobile communication terminal in accordance with the present invention.

In an initial state, if one of the protrusions 113 formed on the rotary switch 110 is inserted into the groove 109 of the locking member 108 and then locked, the rotary switch 110 has a limit on a free rotation, thereby maintaining an initially set position.

At this point, one of the protrusion pieces 112 formed on the rotary switch 110 is disposed at the front portion of the optical sensor 150 and continues to reflect the radiated light toward the light-receiving unit 153. The optical sensor 150 remains at a sensed state. Accordingly, the sub-display 130 continues to display an initial setup screen A.

In this state, if the rotary switch 110 is rotated by one click by the rotation of the rotary ring 120 so that the different protrusion 113 formed adjacent to the current protrusion can be locked into the groove 109 of the locking member 108, there occurs a time when the optical sensor 150 cannot receive the reflected light during the rotation of the rotary switch 110 due to a space between the current protrusion piece and the next protrusion piece. Then, if the next protrusion piece is positioned at the front portion of the optical sensor 150, the light-receiving unit 150 of the optical sensor 150 receives the reflected light again. A new signal generate due to this process is transferred from the optical sensor 150 to the microprocessor 163 of the controller 150.

Accordingly, the microprocessor 163 loads and processes different screen data stored in the memory device 161 according to the inputted signal and transfers the processed signals to the sub-display 130. The display panel 133 displays a screen B of previously set different contents according to the outputs of the microprocessor 163.

In this manner, as the rotary switch 110 is rotated one click by one click, screens C and D of the different contents that the user wants can be displayed. As a result, a variety of desired information can be easily obtained through a simple manipulation without opening the folder, that is, by turning the rotary switch 110. The screens of the sub-display 130 can be configured variously according to the user's taste, thereby improving an adornment effect of the sub-display.

Although the present invention is exemplarily described with the embodiments applied to the sub-display 130, the apparatus for changing the representation contents on the sub-display in accordance with the present invention can also be applied to the case that the sub-display 130 is installed the main body of the terminal.

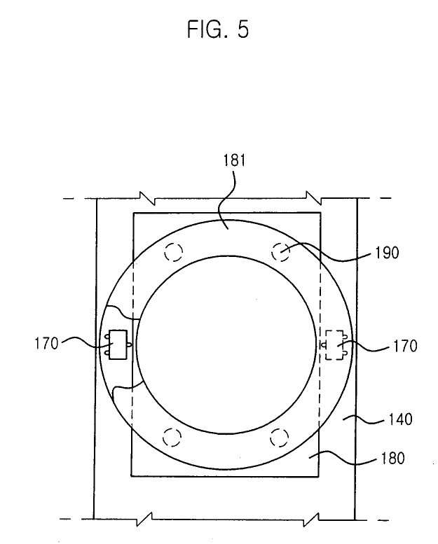

FIG. 5 illustrates an apparatus for changing representation contents on a sub-display in accordance with another embodiment of the present invention. Like the above embodiment of the present invention, a rotary switch 180 is rotatably installed in the circular ring 101 formed on the folder case 100. A rotation detecting sensor 170 for sensing a rotation of the rotary switch 180 to generate a predetermined input signal is installed in a flexible printed circuit (FPC) 140. Here, the rotary switch 180 is made of a plurality of magnets 190, which are insertedly installed in a ring-shaped body 181 and a back of the body 181 at predetermined intervals along a circumferential direction. The rotation detecting sensor 170 is provided with magnetic sensors 170 which are capable of sensing a magnetic force of the magnets 190 installed in the rotary switch 180.

In this embodiment, if the rotary switch 180 is rotated so that the respective magnets 190 are close to both magnetic sensors 170, the magnetic sensors 170 transfers the input signal, which is generated by sensing it, to the controller. Since the other operations and effects except for them are identical to the above embodiment, a detailed description will be omitted.

As described above, in accordance with the present invention, the rotary switch is installed around the sub-display window and the rotation detecting sensor is installed in the back of the rotary switch. Accordingly, the representation contents on the sub-display can be freely changed with the simple manipulation, that is, through a rotation of the rotary switch, so that a variety of information that the user wants can be obtained easily and promptly without opening the folder. Further, the screens of the sub-display can be configured variously according to the user's taste, thereby enhancing the adornment effect.

While the present invention has been described with respect to the particular embodiments, it will be apparent to those skilled in the art that various changes and modifications may be made without departing from the scope of the invention as defined in the following claims.

What is claimed is:

1. An apparatus for changing representation contents on a sub-display of a mobile communication terminal, comprising:
a rotary switch rotatably installed around a front circumferential portion of the sub-display provided in a dual-folder type mobile communication terminal, the rotary switch having an opening formed at a central portion such that the sub-display is exposed outwardly;
a rotation detecting sensor installed adjacent to a back portion of the rotary switch inside a case of the terminal, for sensing a rotation of the rotary switch to generate a predetermine input signal; and
a controller installed inside the case of the terminal, the controller having one side connected to the rotation detecting sensor and the other side connected to the sub-display, wherein the controller generates different output signals according to the input signal outputted from the rotation detecting sensor to thereby display different contents on the sub-display.

2. The apparatus as recited in claim 1, wherein the controller includes:
a memory device installed in one side of a circuit board embedded in the terminal, for storing data to be displayed on the sub-display; and
a microprocessor installed in the other side of the circuit board, for loading and processing the data stored in the memory device according to the input signals outputted from the rotation detecting sensor and transferring the processed signals to the sub-display.

3. The apparatus as recited in claim 1, wherein the rotary switch includes a plurality of protrusions formed on a circumferential portion of the rotary switch at predetermined intervals along a circumferential direction, and a locking member is formed at one side of a terminal case adjacent to the protrusions of the rotary switch, the locking member having a groove formed in a shape corresponding to the protrusion.

4. The apparatus as recited in claim 1, wherein the rotary switch includes:
a body formed in a ring shape; and
a plurality of protrusion pieces protruded inwardly or outwardly in a radial direction at predetermined intervals along a circumferential direction.

5. The apparatus as recited in claim 1, wherein the rotation detecting sensor is an optical sensor, wherein the optical sensor includes:
a light-emitting unit for radiating light toward the protrusion pieces; and
a light-receiving unit for sensing the light reflected by the protrusion pieces.

6. The apparatus as recited in claim 1, wherein the rotary switch includes:
a body formed in a ring shape; and
a plurality of magnets attached to the body at predetermined intervals along a circumferential direction, and
the rotation detecting sensor is a magnetic sensor for sensing a magnetic field of the magnet approaching thereto due to a rotation of the rotary switch.
